(19) United States
(12) Patent Application Publication
(10) Pub. No.: US 2026/0220061 A1
(43) Pub. Date: Jul. 30, 2026

(54) Handling a One-to-Multiple Handshake with Asynchronous Completion

(71) Applicant: Google LLC, Mountain View, CA (US)

(72) Inventors: Mayank Parasrampuria, Bengaluru (IN); Kartik Rao, Bangalore (IN)

(73) Assignee: Google LLC, Mountain View, CA (US)

(21) Appl. No.: 19/040,526

(22) Filed: Jan. 29, 2025

(51) Int. Cl. G06F 13/362

(52) U.S. Cl. CPC G06F 13/3625

(57) ABSTRACT

Techniques and apparatuses are described for handling a one-to-multiple handshake with asynchronous completion. In example aspects, a system-on-chip is implemented with at least one handler, at least one second entity, and at least one subsystem having multiple first entities and at least one scheduler. To facilitate communications between the multiple first entities of the subsystem and the second entity, the handler performs a request-and-acknowledgement handshake with the scheduler. Additionally, the handler performs multiple request-and-acknowledgement handshakes with the second entity. The handler completes the request-and-acknowledgement handshake with the scheduler based on the completion of the multiple request-and-acknowledgement handshakes with the second entity. This enables the handler to address a situation in which the multiple request-and acknowledgement handshakes with the second entity complete in an asynchronous manner.

### BACKGROUND

A system-on-chip (SoC) of an electronic device can be designed with a variety of different subsystems. Technological trends have led these subsystems to have larger quantities of components. In some cases, the components of a subsystem can be implemented within different domains (e.g., different physical partitions and/or different power domains). It can be challenging to communicate data between multiple components within a same domain and another entity that is outside of the subsystem.

### SUMMARY

Techniques and apparatuses are described for handling a one-to-multiple handshake with asynchronous completion. In example aspects, a system-on-chip is implemented with at least one subsystem having multiple first entities and at least one scheduler. The system-on-chip also includes at least one second entity and a handler. To facilitate communications between the multiple first entities and the second entity, the handler executes a one-to-multiple request-and-acknowledgement handshake between the scheduler and the second entity. This one-to-multiple request-and-acknowledgement handshake enables data to pass between the multiple first entities of the subsystem and the second entity. To perform the one-to-multiple request-and-acknowledgement handshake, the handler performs a single request-and-acknowledgement handshake with the scheduler. Additionally, the handler performs multiple request-and-acknowledgement handshakes with the second entity. At least two of the multiple request-and-acknowledgement handshakes can complete in an asynchronous manner (e.g., at different time intervals). To address this asynchronous completion, the handler refrains from completing the request-and-acknowledgement handshake with the scheduler until all of the multiple request-and-acknowledgement handshakes with the second entity are complete.

By handling the one-to-multiple handshake with asynchronous completion, the handler enables the scheduler to be implemented with a less complex and cheaper design (e.g., using single-threaded software). The handler also avoids a potential deadlock scenario that can otherwise occur using other techniques due to the asynchronous nature in which some of the multiple request-and-acknowledgement handshakes with the second entity may be completed. Although the handler can represent a new or additional component of the system-on-chip, the handler can be designed to be relatively efficient in terms of power consumption and area. In this way, the handler does not significantly impact the power consumption and/or footprint of the system-on-chip.

Aspects described below include a method performed by a handler. The method includes executing a one-to-multiple request-and-acknowledgement handshake between a scheduler and a second entity. The scheduler is associated with multiple first entities. The executing includes performing a request-and-acknowledgement handshake with the scheduler and performing multiple request-and-acknowledgement handshakes with the second entity. At least two subsets of the multiple request-and-acknowledgement handshakes complete at different time intervals. The multiple request-and-acknowledgement handshakes are respectively associated with the multiple first entities. The executing also includes completing the request-and-acknowledgement handshake with the scheduler based on the completion of the multiple request-and-acknowledgement handshakes with the second entity.

Aspects described below also include an apparatus with a handler capable of performing any of the described methods.

Aspects described below also include a system with means for handling a one-to-multiple handshake with asynchronous completion.

### BRIEF DESCRIPTION OF DRAWINGS

Apparatuses for and techniques for handling a one-to-multiple handshake with asynchronous completion are described with reference to the following drawings. The same numbers are used throughout the drawings to reference like features and components:

FIG. 1 illustrates an example environment in which techniques for handling a one-to-multiple handshake with asynchronous completion can be implemented;

FIG. 2 illustrates an example implementation of a computing device that can implement aspects of handling a one-to-multiple handshake with asynchronous completion;

FIG. 3 illustrates an example system-on-chip with a handler capable of handling a one-to-multiple handshake with asynchronous completion;

FIG. 4 illustrates an example high-level implementation of a handler that performs aspects of handling a one-to-multiple handshake with asynchronous completion;

FIG. 5 illustrates an example low-level implementation of a handler that performs aspects of handling a one-to-multiple handshake with asynchronous completion;

FIG. 6 illustrates an example implementation of a sticky flip-flop for performing aspects of handling a one-to-multiple handshake with asynchronous completion;

FIG. 7 illustrates an example timing diagram for handling a one-to-multiple handshake with asynchronous completion;

FIG. 8 illustrates an example scheme for handling a one-to-multiple handshake with asynchronous completion;

FIG. 9 illustrates an example method for handling a one-to-multiple handshake with asynchronous completion; and

FIG. 10 illustrates an example computing system embodying, or in which techniques may be implemented that enable use of, handling a one-to-multiple handshake with asynchronous completion.

### DETAILED DESCRIPTION

A system-on-chip (SoC) of an electronic device can be designed with a variety of different subsystems. Technological trends have led these subsystems to have larger quantities of components. In some cases, the components of a subsystem can be implemented within different domains (e.g., different physical partitions and/or different power domains). It can be challenging to communicate data between multiple components within a same domain and another entity that is outside of the subsystem.

To simplify communications, a scheduler can manage a communication handshake between a group of components that are implemented within a same domain of the subsystem and another entity, which is distinct from the subsystem. In some implementations, the scheduler may have a constraint that limits the quantity of handshakes that can be supported. This can present a problem if the limitation causes the scheduler to support fewer handshakes than the quantity of components that exist within the group.

To address this limitation, some schedulers can broadcast a request so that the other entity receives a quantity of requests that are equal to the quantity of components. The scheduler can also combine multiple acknowledgements received from the other entity using an AND logic gate to generate a composite acknowledgement. A problem, however, can occur due to the asynchronous nature of the broadcasted requests and received acknowledgements. In some cases, propagation delays can cause one or more of these signals to become out of synch. In particular, at least two of the broadcasted requests can be received by the other entity on different cycles. The other entity can generate acknowledgements for the broadcasted requests it receives and refrain from generating acknowledgements for the broadcasted requests that were not received (or have yet to be received). This can result in a deadlock scenario in which the request/acknowledgement protocol is unable to complete for the other entity and/or for the scheduler.

To address this challenge, techniques are described for handling a one-to-multiple handshake with asynchronous completion. In example aspects, a system-on-chip is implemented with at least one subsystem having multiple first entities and at least one scheduler. The system-on-chip also includes at least one second entity and a handler. To facilitate communications between the multiple first entities and the second entity, the handler executes a one-to-multiple request-and-acknowledgement handshake between the scheduler and the second entity. This one-to-multiple request-and-acknowledgement handshake enables data to pass between the multiple first entities of the subsystem and the second entity. To perform the one-to-multiple request-and-acknowledgement handshake, the handler performs a single request-and-acknowledgement handshake with the scheduler. Additionally, the handler performs multiple request-and-acknowledgement handshakes with the second entity. At least two of the multiple request-and-acknowledgement handshakes with the second entity can complete in an asynchronous manner (e.g., at different time intervals). To address this asynchronous completion, the handler refrains from completing the request-and-acknowledgement handshake with the scheduler until all of the multiple request-and-acknowledgement handshakes with the second entity are complete.

By handling the one-to-multiple handshake with asynchronous completion, the handler enables the scheduler to be implemented with a less complex and cheaper design (e.g., using single-threaded software). The handler also avoids a potential deadlock scenario that can otherwise occur using other techniques due to the asynchronous nature in which some of the multiple request-and-acknowledgement handshakes with the second entity may be completed. Although the handler can represent a new or additional component of the system-on-chip, the handler can be designed to be relatively efficient in terms of power consumption and area. In this way, the handler does not significantly impact the power consumption and/or footprint of the system-on-chip.

### Operating Environment

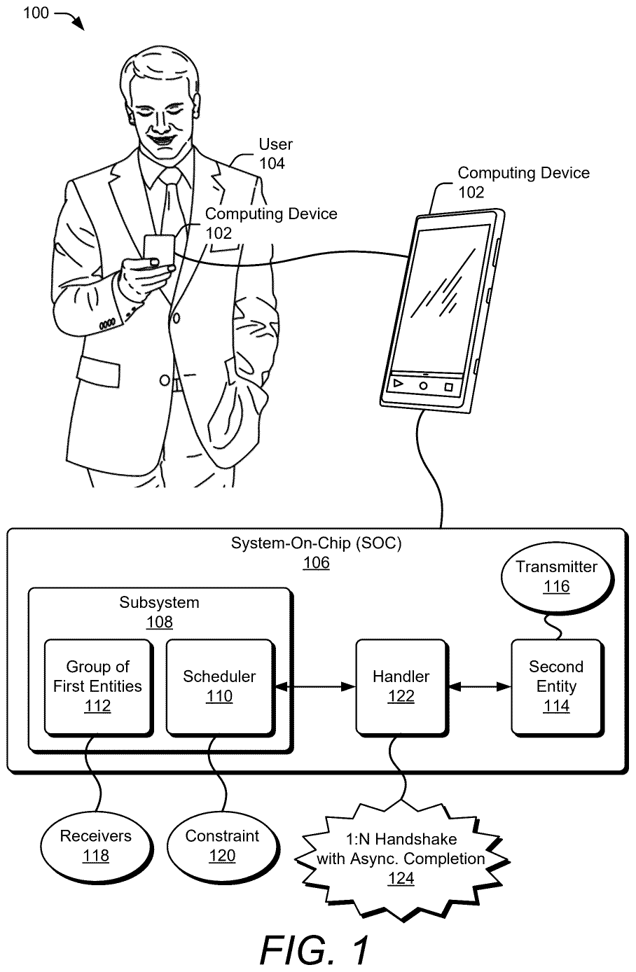

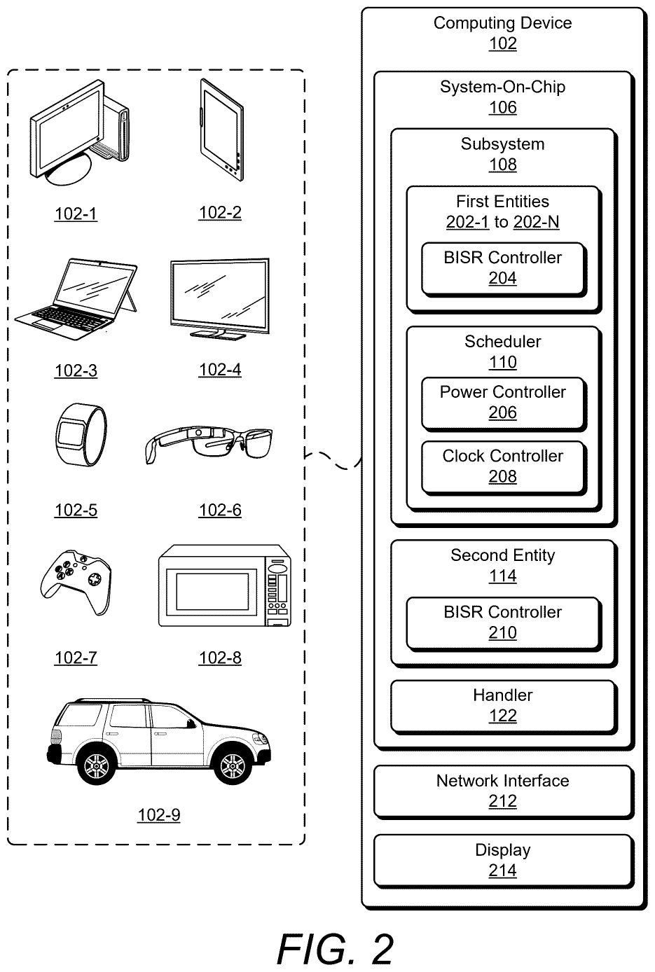

FIG. 1 is an illustration of an example environment 100 in which handling a one-to-multiple handshake with asynchronous completion can be implemented. In the example environment 100, a computing device 102 provides features and/or services for a user 104. Although depicted as a smartphone, the computing device 102 can include other types of devices, including those described with respect to FIG. 2. The computing device 102 includes at least one system-on-chip (SOC) 106 (SOC 106). The system-on-chip 106 can be implemented with electronic circuitry, a microprocessor, memory, input-output (I/O) control logic, communication interfaces, firmware, and/or software useful to provide functionalities of the computing device 102.

The system-on-chip 106 includes at least one subsystem 108. The subsystem 108 can also be referred to as an agent, a module, an intellectual-property block (IP block), an intellectual-property core, or a virtual component. Example subsystems 108 can include a central processing unit (CPU), a graphics processing unit (GPU), an image processing unit (IPU), a modem, a digital signal processor (DSP), a neural processing unit (NPU), a power processing unit (PPU), a display, a processor, a memory, a camera, a sensor, an analog circuit, a digital circuit, components that handle application-specific processing functions, and so forth.

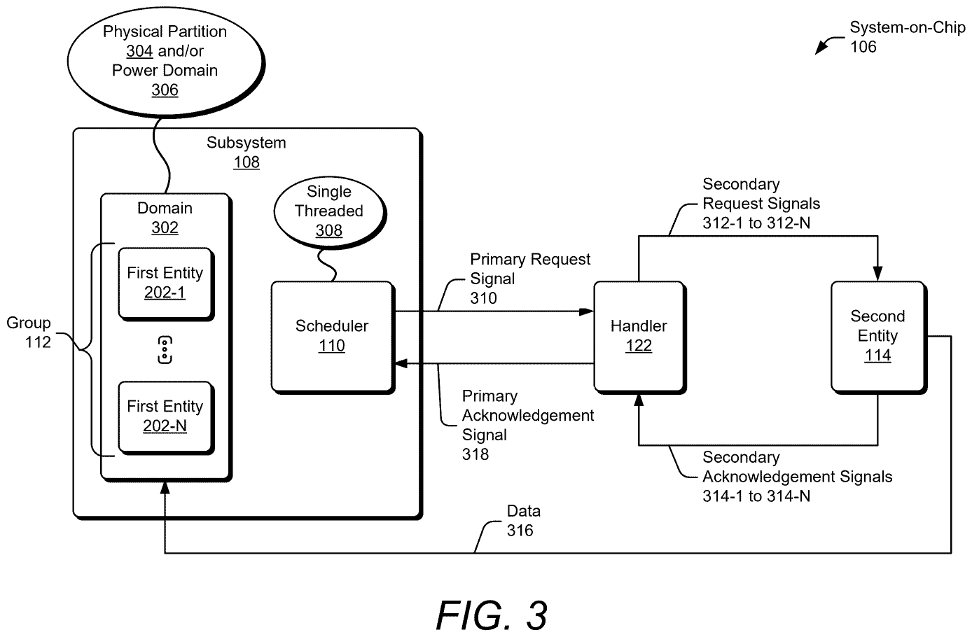

The subsystem 108 includes at least one scheduler 110 and at least one group of first entities 112. The scheduler 110 can be referred to as a task spawner or a controller. The group of first entities 112 can be associated with a same physical partition and/or a same power domain of the subsystem 108, as further described with respect to FIG. 3. The first entities within the group 112 can also be referred to as components of the subsystem 108.

The scheduler 110 manages or facilitates communications between the group of first entities 112 and a second entity 114. In more detail, the scheduler 110 can initiate and participate in a request-and-acknowledgement procedure that enables data to propagate between the group of first entities 112 and the second entity 114. In some situations, the second entity 114 can represent a transmitter 116, and the group of first entities 112 can represent a group of receivers 118. In this case, the second entity 114 can transmit data to the group of first entities 112. In other situations, the second entity 114 can represent the receiver 118 and the group of first entities 112 can represent a group of transmitters 116. In this case, the group of first entities 112 transmit data to the second entity 114. The second entity 114 can be another subsystem (or a component of another subsystem) that is distinct or separate from the subsystem 108 that includes the group of first entities 112.

In some implementations, the scheduler 110 is designed with a constraint 120 that limits a quantity of request-and-acknowledgement handshakes that can be performed in parallel. If the constraint 120 causes the quantity of request-and-acknowledgement handshakes that can be performed in parallel to be less than a quantity of first entities within the group 112, the scheduler 110 is unable to directly perform multiple request-and-acknowledgement handshakes between the individual first entities within the group 112 and the second entity 114. For example, the scheduler 110 can be designed with single-threaded software capable of performing a single request-and-acknowledgement handshake. Other examples are also possible, such as the scheduler 110 being designed with a multi-threaded software capable in which a quantity of threads that can be supported by the multi-threaded software is fewer than the quantity of first entities within the group 112. To overcome this constraint 120, the system-on-chip 106 includes at least one handler 122.

The handler 122 is capable of performing, at least in part, a one-to-multiple (1:N) handshake that handles (or supports) asynchronous completion 124 (1:N handshake with Async. Completion 124). The one-to-multiple handshake that handles asynchronous completion 124 can also be referred to as the one-to-multiple handshake 124 for brevity. To perform the one-to-multiple handshake, the handler 122 performs a request-and-acknowledgement handshake (e.g., a single request-and-acknowledgement handshake) with the scheduler 110. Additionally, the handler 122 performs multiple request-and-acknowledgement handshakes with the second entity 114. At least two of the multiple request-and-acknowledgement handshakes with the second entity 114 can complete in an asynchronous manner (e.g., at different time intervals). To address this asynchronous completion, the handler 122 refrains from completing the request-and-acknowledgement handshake with the scheduler 110 until all of the multiple request-and-acknowledgement handshakes with the second entity 114 are complete. In this way, the handler 122 can avoid a potential deadlock scenario that can otherwise occur using other techniques due to the asynchronous nature in which some of the multiple request-and-acknowledgement handshakes with the second entity may be completed.

The components of the system-on-chip 106 (e.g., the subsystems 108, the second entity 114, and the handler 122) can alternatively be implemented within other types of integrated circuits or embedded systems, such as a microchip, an application-specific integrated circuit (ASIC), an application-specific standard product (ASSP), a digital signal processor (DSP), a programmable system-on-chip (PSoC), system-in-package (SiP), controller, and so forth. Although a single subsystem 108 is shown in FIG. 1, it can be understood that the system-on-chip 106 can include multiple subsystems 108. Furthermore, although the subsystem 108 is shown to include one scheduler 110 and a single group of first entities 112 in FIG. 1, other implementations are also possible in which the subsystem 108 includes multiple schedulers 110 and multiple groups of first entities 112.

In various implementations, the system-on-chip 106 can include at least one handler 122 for each scheduler 110. For example, if the subsystem 108 includes multiple schedulers 110, the system-on-chip 106 can include a handler 122 for each scheduler 110. Other implementations are also possible in which one handler 122 can execute the one-to-multiple handshake 124 for multiple schedulers 110 associated with different subsystems 108 or multiple schedulers 110 associated with a same subsystem 108. In this case, the system-on-chip 106 can be designed with additional logic to enable the second entity 114 to associate a one-to-multiple handshake with a particular group of entities 112. Additionally, the system-on-chip 106 can include timing logic that provides some form of synchronization across the multiple schedulers 110 to avoid conflicts in utilizing the handler 122. The computing device 102 is further described with respect to FIG. 2.

FIG. 2 illustrates an example computing device 102. The computing device 102 is illustrated with various non-limiting example devices, including a desktop computer 102-1, a tablet 102-2, a laptop 102-3, a television 102-4, a computing watch 102-5, computing glasses 102-6, a gaming system 102-7, a microwave 102-8, and a vehicle 102-9. Other devices may also be used, including a hearable, a home service device, a smart speaker, a smart thermostat, a baby monitor, a Wi-Fi™ router, a drone, a trackpad, a drawing pad, a netbook, an e-reader, a home automation and control system, a wall display, or another home appliance. Note that the computing device 102 can be wearable, non-wearable but mobile, or relatively immobile (e.g., desktops and appliances). The computing device 102 includes at least one system-on-chip 106 with at least one subsystem 108. The subsystem 108 includes first entities 202-1 to 202-N and the scheduler 110. The first entities 202-1 to 202-N are part of the group of first entities 112, as described in FIG. 1. The variable N represents a positive integer that is greater than one.

In an example implementation, the first entities 202-1 to 202-N can be implemented as built-in self-refresh controllers 204 (BISR controllers 204). The built-in self-refresh controllers 204 can perform, at least in part, a built-in self-refresh procedure on respective memory elements that are part of the subsystem 108. In some implementations, the built-in self-refresh controllers 204 represent a chain of built-in self-refresh controllers.

The scheduler 110 is generally implemented as a software-based controller. This enables the scheduler 110 to be readily configured for various subsystems 108 and/or for various first entities 202. The software-based controller can be single threaded or multi-threaded. Due to the constraint 120, the quantity of threads that can be executed in parallel by the software-based controller is fewer than the quantity of first entities 202 (e.g., the quantity of threads is less than N).

In an example implementation, the scheduler 110 can be implemented as a power controller 206 and/or a clock controller 208. The power controller 206 selectively activates or deactivates a power domain associated with the first entities 202 to manage power consumption of the subsystem 108. The clock controller 208 controls a timing of one or more operations performed by the first entities 202.

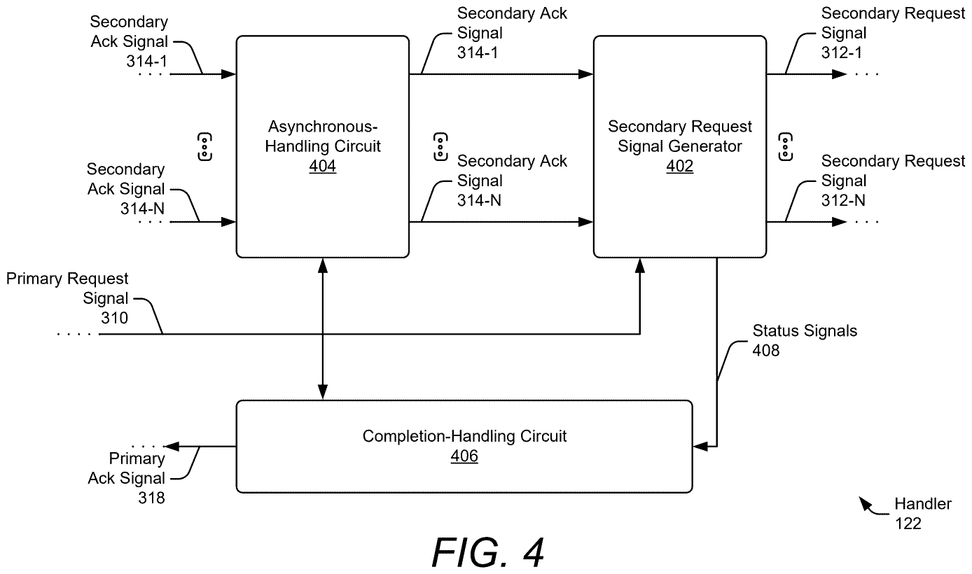

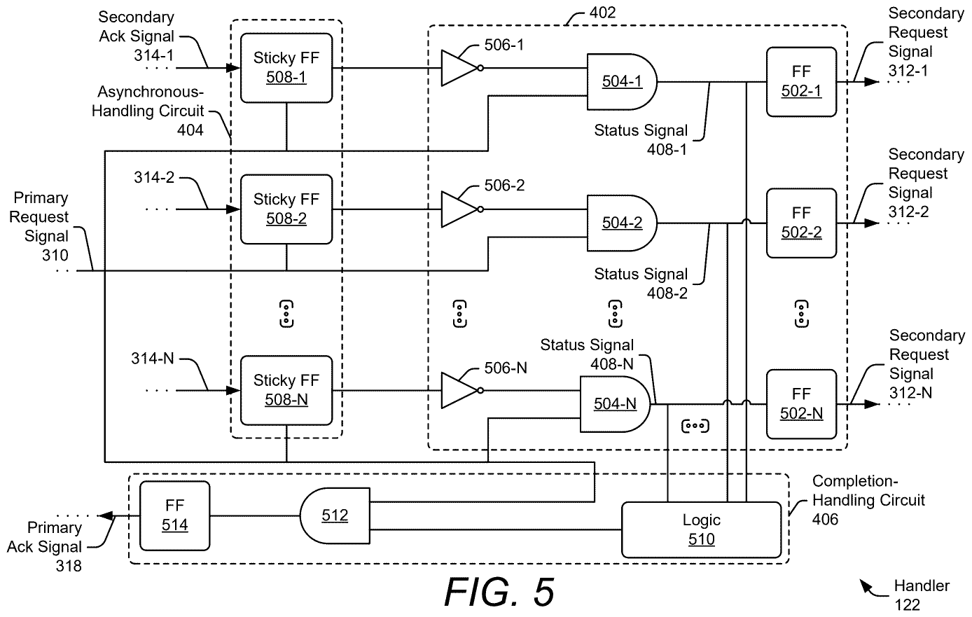

The system-on-chip 106 also includes the second entity 114 and the handler 122. In an example implementation, the second entity 114 can be another built-in self-repair controller 210 or a built-in self-test controller that can pass data associated with a built-in self-repair procedure to the built-in self-refresh controllers 204 of the subsystem 108. The handler 122 can be implemented using hardware components, as further described with respect to FIGS. 4 and 5.

The computing device 102 can additionally include a network interface 212 for communicating data over wired, wireless, or optical networks. For example, the network interface 212 may communicate data over a local-area-network (LAN), a wireless local-area-network (WLAN), a personal-area-network (PAN), a wide-area-network (WAN), an intranet, the Internet, a peer-to-peer network, point-to-point network, a mesh network, Bluetooth™, and the like. The computing device 102 may also include a display 214. An example relationship between the scheduler 110, the handler 122, and the second entity 114 is further described with respect to FIG. 3.

### Handling a One-to-Multiple Handshake with Asynchronous Completion

FIG. 3 illustrates an example system-on-chip 106 with a handler 122 capable of handling a one-to-multiple handshake with asynchronous completion 124. The system-on-chip 106 includes the subsystem 108, which includes the scheduler 110 and the first entities 202-1 to 202-N, which represent the group of first entities 112 shown in FIG. 1. The scheduler 110 is associated with the first entities 202-1 to 202-N and generally controls the scheduling of communications of the first entities 202 with another entity of the system-on-chip 106 (e.g., the second entity 114).

The first entities 202-1 to 202-N are associated with a same domain 302 of the subsystem 108. The domain 302 can represent a physical partition 304 of the subsystem 108 and/or a power domain 306 of the subsystem 108. By being part of the same domain 302, the scheduler 110 can readily activate (e.g., enable) and/or deactivate (e.g., disable) the first entities 202. Although not explicitly shown, some implementations of the subsystem 108 can include other domains with other first entities, and can include other schedulers 110 that are associated with these other first entities.

In this example, the scheduler 110 is single threaded 308. This means that the scheduler 110 is unable to execute multiple threads in parallel. Although not explicitly shown in FIG. 3, the scheduler 110 can be coupled to the first entities 202. In some implementations, the scheduler 110 provides timing signals to the first entities 202.

The system-on-chip 106 also includes the handler 122 and the second entity 114. The handler 122 is coupled between the scheduler 110 and the second entity 114. As further described below, the handler 122 can map a request provided by the scheduler 110 into multiple requests. The handler 122 can also map multiple acknowledgements that are provided by the second entity 114 into a single acknowledgement.

Consider an example in which the second entity 114 operates as the transmitter 116 and the first entities 202 operate as receivers 118. During an operation of the system-on-chip 106, the scheduler 110 and the handler 122 perform a request-and-acknowledgement handshake. In particular, the scheduler 110 generates a primary request signal 310 that is asserted. The assertion of the primary request signal 310 represents a request for the second entity 114 to provide data to the first entities 202.

The handler 122 receives the primary request signal 310. The handler 122 also performs multiple request-and-acknowledgement handshakes with the second entity 114 based on the assertion of the primary request signal 310. In more detail, the handler 122 generates multiple secondary request signals 312-1 to 312-N. Each secondary request signal 312 is asserted based on the assertion of the primary request signal 310. The assertions of the secondary request signals 312 indicate, to the secondary entity 114, that data is requested by the first entities 202. The multiple secondary request signals 312 respectively correspond to the multiple first entities 202.

The second entity 114 generates multiple secondary acknowledgement signals 314-1 to 314-N based on the multiple secondary request signals 312-1 to 312-N. The multiple secondary acknowledgement signals 314 respectively correspond to the multiple first entities 202. The second entity 114 also transmits data 316 to the first entities 202. Each secondary acknowledgement signal 314 is asserted to indicate that the data 316 has been transmitted to the corresponding first entity 212.

In an example situation, the second entity 114 can assert at least two subsets of the secondary acknowledgement signals 314 at different time intervals (e.g., during different clock cycles). This can occur, for instance, if the second entity 114 receives the assertions of at least two subsets of the secondary request signals 312 at different time intervals due to differences in propagation delays of the at least two subsets of secondary request signals 312. This means that different subsets of the multiple request-and-acknowledgement handshakes between the second entity 114 and the handler 122 can complete at different time intervals.

The handler 122 generates a primary acknowledgement signal 318 based on the secondary acknowledgement signals 314. The handler 122 refrains from completing the request-and-acknowledgement handshake with the scheduler 110 until the multiple request-and-acknowledgement handshakes between the handler 122 and the second entity 114 have completed. In other words, the handler 122 refrains from asserting the primary acknowledgement signal 318 until all of the secondary acknowledgement signals 314 have been asserted. In this way, the handler 122 handles the asynchronous completion of the multiple request-and-acknowledgement handshakes with the second entity 114 while avoiding a deadlock scenario that can otherwise occur with other techniques. An example implementation of the handler 122 is further described with respect to FIGS. 4 and 5.

FIG. 4 illustrates an example high-level implementation of the handler 122. In the depicted configuration, the handler 122 includes at least one secondary request signal generator 402, at least one asynchronous-handling circuit 404, and at least one completion-handling circuit 406. The secondary request signal generator 402 is coupled to the scheduler 110 (not shown) and the second entity 114 (not shown). The secondary request signal generator 402 generates the multiple secondary request signals 312 based on the primary request signal 310 and based on the secondary acknowledgement signals 314.

The secondary request signal generator 402 also generates status signals 408. Each status signal 408 can represent a combination of the primary request signal 310 with a corresponding secondary acknowledgement signal 314 (or version thereof). In general, each status signal 408 indicates completion (or lack of completion) of one of the multiple handshakes performed between the handler 122 and the second entity 114. The secondary request signal generator 402 can be implemented using flip-flops, logic gates (e.g., AND gates), and inverters, as further described with respect to FIG. 5.

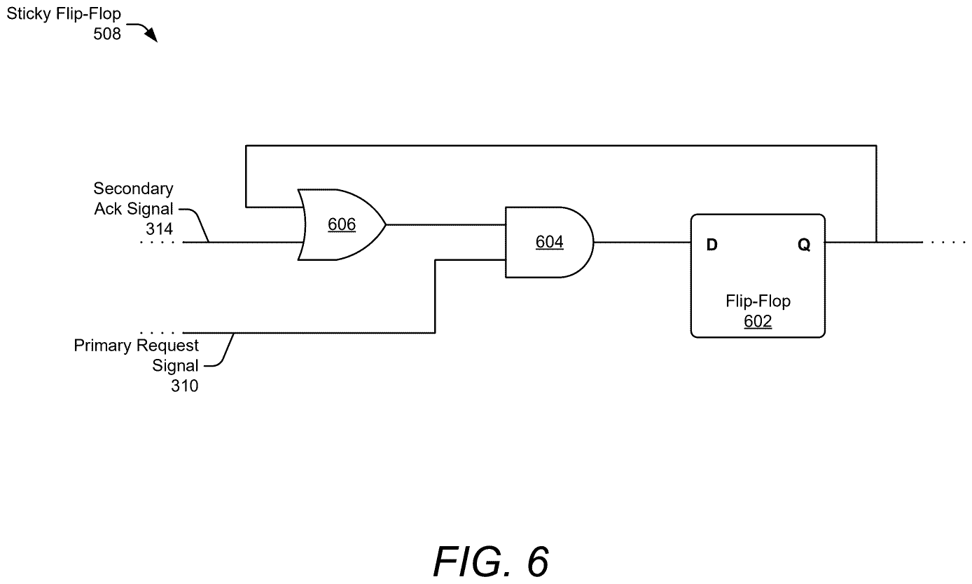

The asynchronous-handling circuit 404 is coupled to the scheduler 110 (not shown), the second entity 114 (not shown), and the secondary request signal generator 402. The asynchronous-handling circuit 404 captures and holds the secondary acknowledgement signals 314 until the primary request signal 310 is de-asserted. Additionally, the asynchronous-handling circuit 404 passes the secondary acknowledgement signals 314 to the secondary request signal generator 402. The asynchronous-handling circuit 404 can be implemented using sticky flip-flops, which are further described with respect to FIG. 6.

The completion-handling circuit 406 is coupled to the scheduler 110 (not shown) and the secondary request signal generator 402. The completion-handling circuit 406 refrains from completing the handshake with the scheduler 110 until the multiple handshakes with the second entity 114 have completed, as indicated by the status signals 408. The completion-handling circuit 406 generates the primary acknowledgement signal 318 based at least on the status signals 408. The completion-handling circuit 406 can be implemented using logic gates and a flip-flop, as further described with respect to FIG. 5.

FIG. 5 illustrates a low-level implementation of the handler 122. In the depicted configuration, the secondary request signal generator 402 includes multiple flip-flops 502-1, 502-2 . . . 502-N (FF 502-1 to 502-N), multiple AND gates 504-1, 504-2 . . . 504-N, and multiple inverters 506-1, 506-2 . . . 506-N. The AND gates 504 are coupled between an input of the flip-flops 502 and an output of the inverters 506. Outputs of the flip-flops 502 are coupled to the second entity 114 (not shown). The flip-flops 502 can be implemented as D-type flip-flops.

The asynchronous-handling circuit 404 includes multiple sticky flip-flops 508-1, 508-2 . . . 508-N. Inputs of the sticky flip-flops 508 are coupled to the scheduler 110 (not shown) and the second entity 114 (not shown). Outputs of the sticky flip-flops 508 are coupled to inputs of the inverters 506. An example implementation of the sticky flip-flop 508 is further described with respect to FIG. 6.

The completion-handling circuit 406 includes logic 510, an AND gate 512, and a flip-flop 514. The logic 510 combines the status signals 408 provided by the secondary request signal generator 402 to determine if the multiple handshakes between the handler 122 and the second entity 114 have completed. The logic 510 can be implemented using an AND gate 512 having N inverted inputs. The AND gate 512 is coupled between an output of the logic 510 and an input of the flip-flop 514.

Consider a situation in which the sticky flip-flops 508 were previously reset and the primary request signal 310 is not asserted. In this case, the signals provided by the sticky flip-flops 508 to the secondary request signal generator 402 are not asserted. The secondary request signal generator 402 generates the secondary request signals 312, which are not asserted due to the de-asserted state of the primary request signal 310 and the AND gates 504.

Once the primary request signal 310 is asserted by the scheduler 110, the status signals 408 are asserted. The flip-flops 502 capture and hold the status signals 408 to generate the secondary request signals 312. As such, the secondary request signal generator 402 asserts all of the secondary request signals 312 based on the assertion of the primary request signal 310.

Over time, the second entity 114 asserts the secondary acknowledgement signals 314. The sticky flip-flops 508 capture and hold the secondary acknowledgement signals 314. As each secondary acknowledgement signal 314 is asserted, the corresponding status signal 408 and the corresponding secondary request signal 312 are de-asserted by the secondary request signal generator 402. Once all of the status signals 408 are de-asserted, the logic 510 and the AND gate 512 causes the flip-flop 514 to de-assert the primary acknowledgement signal 318.

The de-assertion of the primary acknowledgement signal 318 causes the scheduler 110 to de-assert the primary request signal 310. The de-assertion of the primary request signal 310 causes outputs of the sticky flip-flops 508 to be reset to a de-asserted state. This reset configures the handler 122 so that the handler 122 can re-assert the secondary request signals 312 based on a next or later assertion of the primary request signal 310.

Use of the sticky flip-flops 508 ensures that the secondary request signals 312 do not get asserted again until the primary request signal 310 transitions from an asserted state to a de-asserted state. This means that the handler 122 does not perform another handshake with the scheduler 110 until the handshakes with the second entity 114 have completed. The sticky flip-flop 508 is further described with respect to FIG. 6.

FIG. 6 illustrates an example implementation of the sticky flip-flop 508. In the depicted configuration, the sticky flip-flop 508 includes at least one flip-flop 602, at least one AND gate 604, and at least one OR gate 606. The flip-flop 602 represents a D-type flip-flop. An input (e.g., a data input) of the flip-flop 602 is coupled to an output of the AND gate 604. Inputs of the AND gate 604 are coupled to the scheduler 110 (not shown) and an output of the OR gate 606. Inputs of the OR gate 606 are coupled to the second entity 114 (not shown) and an output of the flip-flop 602.

During operation, the flip-flop 602 starts out in a reset state. This means that an output signal generated by the flip-flop is initially in a de-asserted state. Once the primary request signal 310 and the secondary acknowledgement signal 314 are asserted, the output signal generated by the flip-flop 602 is asserted. The flip-flop 602 holds the output signal at the asserted state until it is reset by the primary request signal 310 being de-asserted.

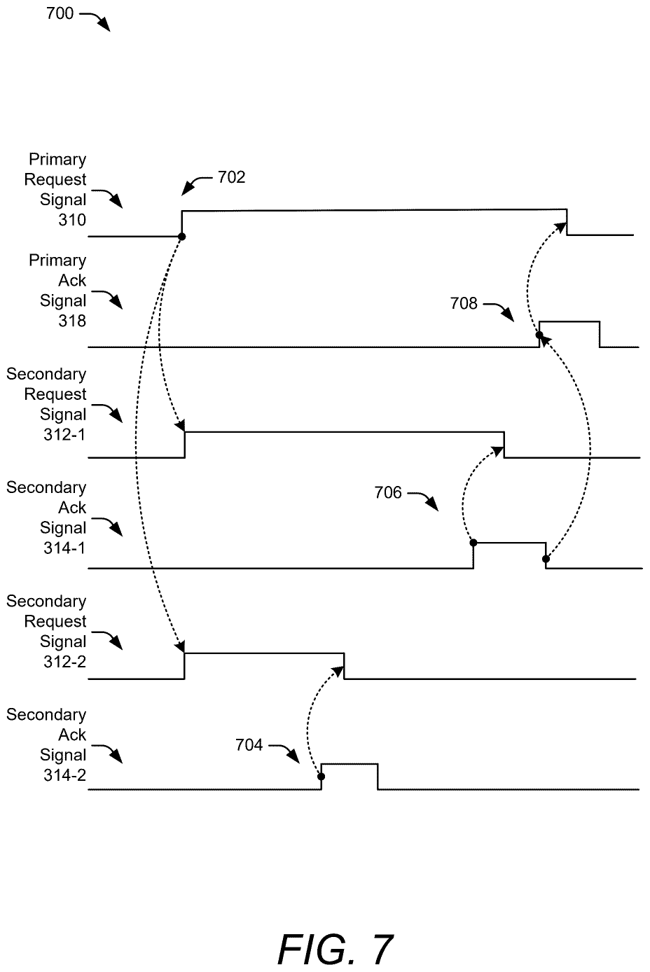

FIG. 7 illustrates an example timing diagram 700 for handling a one-to-multiple handshake with asynchronous completion 124. The timing diagram 700 depicts the assertion and de-assertion of the primary request signal 310, the primary acknowledgement signal 318, the secondary request signals 312-1 and 312-2, and the secondary acknowledgement signals 314-1 and 314-2.

At 702, the primary request signal 310 is asserted by the scheduler 110. This causes the handler 122 to assert the secondary request signals 312-1 and 312-2. At 704, the second entity 114 asserts the secondary acknowledgement signal 314-2. This causes the handler 122 to de-assert the secondary request signal 312-2, which corresponds with the secondary acknowledgement signal 314-2. At 706, the second entity 114 asserts the secondary acknowledgement signal 314-1. This causes the handler 122 to de-assert the secondary request signal 312-1, which corresponds with the secondary acknowledgement signal 314-1. As indicated at 704 and 706, the handshakes between the handler 122 and the second entity 114 are completed during different time intervals (e.g., during different clock cycles).

At 708, the handler 122 asserts the primary acknowledgement signal 318 based on the assertion of the secondary acknowledgement signals 314-1 and 314-2. This causes the scheduler 110 to de-assert the primary request signal 310. As can be seen at 708, the handler 122 refrains from completing the handshake with the scheduler 110 until all of the handshakes between the handler 122 and the second entity 114 have completed (e.g., until the handshake associated with the first pair of signals 312-1 and 314-1 and the handshake associated with the second pair of signals 312-2 and 314-2 have completed).

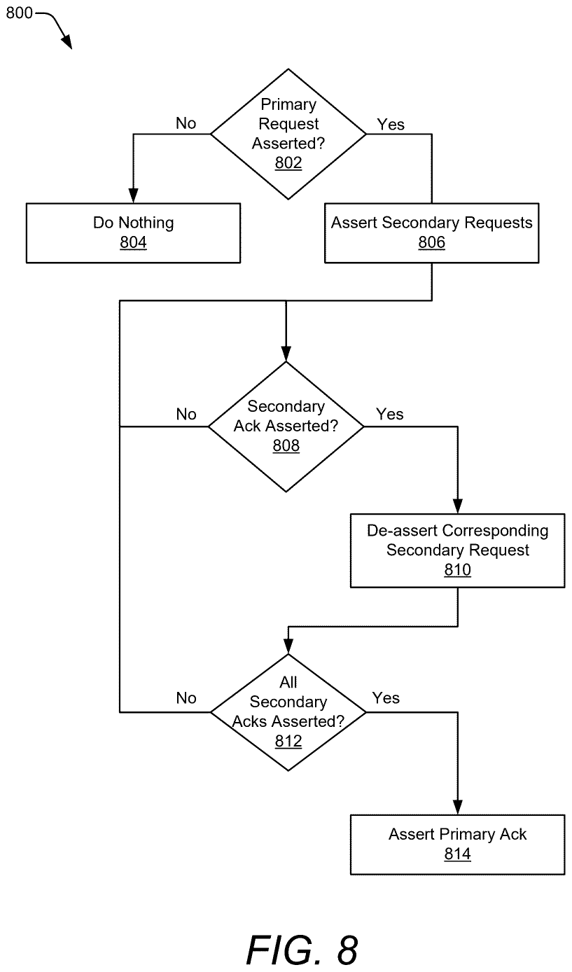

FIG. 8 illustrates an example scheme 800 performed by the handler 122 to handle a one-to-multiple handshake with asynchronous completion 124. At 802, the handler 122 determines if a primary request has been asserted. For example, the handler 122 uses the secondary request signal generator 402 to determine if the scheduler 110 has asserted the primary request signal 310. If the primary request has not been asserted, the handler 122 does nothing, as indicated at 804. Otherwise, the process continues at 806.

At 806, secondary requests are asserted based on the assertion of the primary request. For example, the secondary request signal generator 402 asserts the secondary request signals 312. At 808, the handler 122 determines if a secondary acknowledgement has been asserted 808. For example the handler 122 uses the asynchronous-handling circuit 404 to determine if the second entity 114 has asserted one of the secondary acknowledgement signals 314. If the secondary acknowledgement signal 314 has not been asserted (e.g., has not changed from a de-asserted state to an asserted state), the handler 122 continues monitoring the secondary acknowledgement signals 314, and the process returns to 808. Otherwise, if one of the secondary acknowledgement signals 314 have been asserted, the process continues to 810.

At 810, the handler 122 de-asserts a secondary request that corresponds to the asserted secondary acknowledgement. For example, the handler 122 uses the secondary request signal generator 402 to de-assert a secondary request signal 312 that corresponds with the secondary acknowledgement signal 314 that is asserted by the second entity 114.

At 812, the handler 122 determines if all secondary acknowledgements have been asserted (e.g., if all secondary requests have been de-asserted). For example, the completion-handling circuit 406 determines if all of the secondary acknowledgement signals 314 have been asserted based on the corresponding status signals 408. If some of the secondary acknowledgement signals 314 have not been asserted, the process returns to 808. Otherwise, the process continues at 814.

At 814, the handler 122 asserts the primary acknowledgement. For example, the completion-handling circuit 406 asserts the primary acknowledgement signal 318. This indicates completion of the handshake between the scheduler 110 and the handler 122.

### Example Method

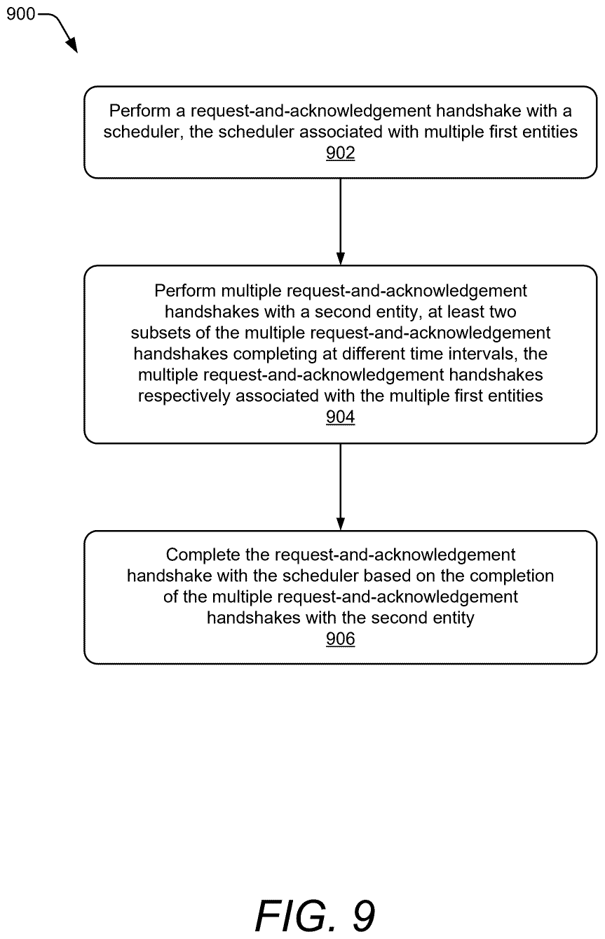

FIG. 9 depicts an example method 900 for implementing aspects of handling a one-to-multiple handshake with asynchronous completion. Method 900 is shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIG. 2, reference to which is made for example only. The techniques are not limited to performance by one entity or multiple entities operating on one device.

Generally speaking, the method 900 describes a process that is performed by a handler 122 for executing a one-to-multiple request-and-acknowledgement handshake 124 between a scheduler 110 and a second entity 114. At 902, a request-and-acknowledgement handshake is performed with a scheduler. The scheduler is associated with multiple first entities. For example, the handler 122 performs a request-and-acknowledgement handshake with the scheduler 110. This handshake includes receiving a primary request signal 310 from the scheduler 110 and transmitting the primary acknowledgement signal 318 to the scheduler 110, as shown in FIG. 3. The scheduler 110 is associated with multiple first entities 202. This means that the scheduler 110 controls or manages the scheduling of communications between the first entities 202 and a second entity 114. The first entities 202 are associated with a same domain 302 of the subsystem 108, as shown in FIG. 3. In an example implementation in which the scheduler 110 represents a single-threaded software-based controller, the request-and-acknowledgement handshake can represent a single request-and-acknowledgement handshake.

At 904, multiple request-and-acknowledgement handshakes are performed with the second entity. At least two subsets of the multiple request-and-acknowledgement handshakes complete at different time intervals. The multiple request-and-acknowledgement handshakes are respectively associated with the multiple first entities. For example, the handler 122 performs multiple request-and-acknowledgement handshakes with the second entity 114. Each one of the multiple request-and-acknowledgement handshakes with the second entity 114 involve the handler 122 transmitting a secondary request signal 312 to the second entity 114 and receiving, from the second entity 114, a secondary acknowledgement signal 314 that corresponds to the transmitted secondary request signal 312, as shown in FIG. 3. The multiple request-and-acknowledgement handshakes are respectively associated with the multiple first entities 202.

At least two subsets of the multiple request-and-acknowledgement handshakes complete at different time intervals (e.g., during different clock cycles). For example, a first handshake associated with the secondary request and acknowledgement signals 312-1 and 314-1 complete at a different time interval compared to a second handshake associated with the secondary request and acknowledgement signals 312-2 and 314-2, as shown at 704 and 706 in FIG. 7.

At 906, the request-and-acknowledgement handshake with the scheduler is completed based on the completion of the multiple request-and-acknowledgement handshakes with the second entity. For example, the handler 122 completes the request-and-acknowledgement handshake with the scheduler 110 based on the completion of the multiple request-and-acknowledgement handshakes with the second entity 114. In more detail, the handler 122 refrains from asserting the primary acknowledgement signal 318 until all of the secondary acknowledgement signals 314 have been asserted by the second entity 114, as shown at 708 in FIG. 7 and at 814 in FIG. 8.

### Example Computing System

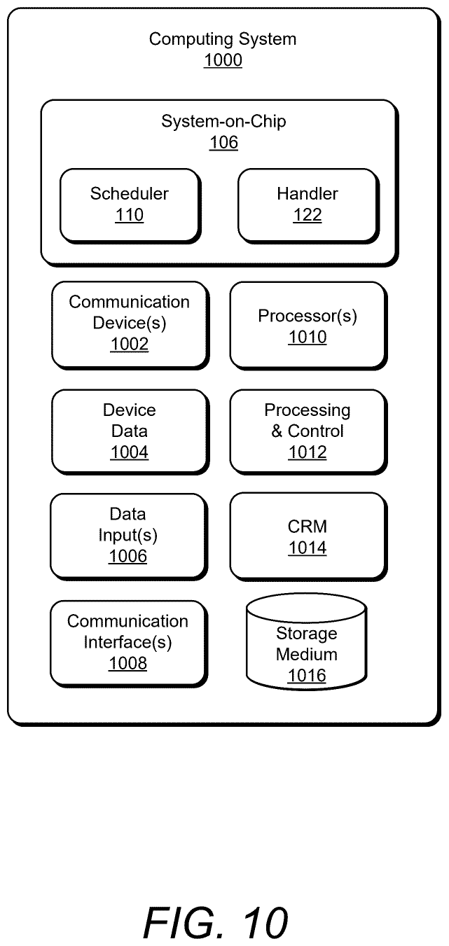

FIG. 10 illustrates various components of an example computing system 1000 that can be implemented as any type of client, server, and/or computing device as described with reference to the previous FIG. 2 to implement aspects of handling a one-to-multiple handshake with asynchronous completion.

The computing system 1000 includes communication devices 1002 that enable wired and/or wireless communication of device data 1004 (e.g., received data, data that is being received, data scheduled for broadcast, or data packets of the data). The device data 1004 or other device content can include configuration settings of the device, media content stored on the device, and/or information associated with a user of the device. Media content stored on the computing system 1000 can include any type of audio, video, and/or image data. The computing system 1000 includes one or more data inputs 1006 via which any type of data, media content, and/or inputs can be received.

The computing system 1000 also includes communication interfaces 1008, which can be implemented as any one or more of a serial and/or parallel interface, a wireless interface, any type of network interface, a modem, and as any other type of communication interface. The communication interfaces 1008 provide a connection and/or communication links between the computing system 1000 and a communication network by which other electronic, computing, and communication devices communicate data with the computing system 1000.

The computing system 1000 includes one or more processors 1010 (e.g., any of microprocessors, controllers, and the like), which process various computer-executable instructions to control the operation of the computing system 1000. Alternatively or in addition, the computing system 1000 can be implemented with any one or combination of hardware, firmware, or fixed logic circuitry that is implemented in connection with processing and control circuits which are generally identified at 1012. Although not shown, the computing system 1000 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1000 also includes a computer-readable medium 1014 (CRM 1014), such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 1000 can also include a mass storage medium device (storage medium) 1016.

The computer-readable medium 1014 provides data storage mechanisms to store the device data 1004, as well as various device applications and any other types of information and/or data related to operational aspects of the computing system 1000. For example, an operating system can be maintained as a computer application with the computer-readable medium 1014 and executed on the processors 1010. The device applications may include a device manager, such as any form of a control application, software application, signal-processing and control module, code that is native to a particular device, a hardware abstraction layer for a particular device, and so on.

The computing system 1000 also includes at least system-on-chip 106. The system-on-chip 106 includes at least one scheduler 110 and at least one handler 122. The handler 122 is capable of performing aspects of handling a one-to-multiple handshake with asynchronous completion. Although not explicitly shown in FIG. 10, the system-on-chip 106 can also include the first entities 202 and the second entity 114.

### Conclusion

Although techniques using, and apparatuses including, handling a one-to-multiple handshake with asynchronous completion have been described in language specific to features and/or methods, it is to be understood that the subject of the appended claims is not necessarily limited to the specific features or methods described. Rather, the specific features and methods are disclosed as example implementations of handling a one-to-multiple handshake with asynchronous completion.

Some Examples are described below.

Example 1: A method performed by a handler, the method comprising:
executing a one-to-multiple request-and-acknowledgement handshake between a scheduler and a second entity, the scheduler associated with multiple first entities, the executing comprising:
   performing a request-and-acknowledgement handshake with the scheduler;
   performing multiple request-and-acknowledgement handshakes with the second entity, at least two subsets of the multiple request-and-acknowledgement handshakes completing at different time intervals, the multiple request-and-acknowledgement handshakes respectively associated with the multiple first entities; and
   completing the request-and-acknowledgement handshake with the scheduler based on the completion of the multiple request-and-acknowledgement handshakes with the second entity.

Example 2: The method of example 1, wherein the execution of the one-to-multiple request-and-acknowledgement handshake enables data to be transferred between the second entity and the first entities.

Example 3: The method of example 1 or 2, wherein:
the performing of the multiple request-and-acknowledgement handshakes comprises receiving, from the second entity, multiple secondary acknowledgement signals, at least two subsets of the multiple secondary acknowledgement signals being asserted at the different time intervals, the multiple secondary acknowledgement signals respectively corresponding to the multiple first entities; and
the completing of the request-and-acknowledgement handshake with the scheduler comprises transmitting, to the scheduler, a primary acknowledgement signal that is asserted based on all of the multiple secondary acknowledgement signals being asserted.

Example 4: The method of example 3, wherein:
the performing of the request-and-acknowledgement handshake with the scheduler comprises, receiving, from the scheduler and prior to the receiving of the multiple secondary acknowledgement signals, a primary request signal that is asserted; and
the performing of the multiple request-and-acknowledgement handshakes comprises, transmitting, to the second entity and prior to the receiving of the multiple secondary acknowledgement signals, multiple secondary request signals that are asserted, the multiple secondary request signals respectively corresponding to the multiple first entities.

Example 5: The method of example 4, wherein the receiving of the multiple secondary acknowledgement signals comprises:
receiving, from the second entity, a secondary acknowledgement signal of the multiple secondary acknowledgement signals, the received secondary acknowledgement signal being asserted; and
de-asserting, based on the received secondary acknowledgement signal being asserted, a secondary request signal of the multiple secondary request signals that corresponds to the received secondary acknowledgement signal.

Example 6: The method of example 5, further comprising:
receiving, from the scheduler and after the transmitting of the primary acknowledgement signal, the primary request signal that is de-asserted; and
resetting, based on the primary request signal being de-asserted, a configuration of the handler to enable the multiple secondary request signals to be re-asserted based on a later assertion of the primary request signal.

Example 7: The method of example 6, further comprising:
prior to the receiving of the primary request signal that is de-asserted, refraining from reasserting the multiple secondary request signals.

Example 8: An apparatus comprising:
a handler configured to:
   be coupled between a scheduler and a second entity, the scheduler associated with multiple first entities;
   perform a request-and-acknowledgement handshake with the scheduler;
   perform multiple request-and-acknowledgement handshakes with the second entity, at least two subsets of the multiple request-and-acknowledgement handshakes completing at different time intervals, the multiple request-and-acknowledgement handshakes respectively associated with the multiple first entities; and
   completing the request-and-acknowledgement handshake with the scheduler based on the completion of the multiple request-and-acknowledgement handshakes with the second entity.

Example 9: the apparatus of Example 8, further comprising:
a system-on-chip comprising:
   the handler;
   the second entity; and
   a subsystem comprising the scheduler and the multiple first entities.

Example 10: The apparatus of example 9, wherein the multiple first entities are associated with a same physical domain or a same power domain of the subsystem.

Example 11: The apparatus of example 9 or 10, wherein the second entity and the first entities are configured to communicate data based on the completion of the request-and-acknowledgement handshake between the scheduler and handler and based on the completion of the multiple request-and-acknowledgement handshakes between the second entity and the handler.

Example 12: The apparatus of example 11, wherein:
the second entity is configured to transmit the data to the first entities; or
the first entities are configured to transmit the data to the second entity.

Example 13: The apparatus of example 12, wherein:
the data comprises data associated with a built-in self-repair procedure;
the second entity and the first entities each comprise built-in self-repair controllers;
the first entities are coupled to memory components of the subsystem; and
the second entity is configured to transmit the data associated with the built-in self-repair procedure to the first entities.

Example 14: The apparatus of any one of examples 9 to 13, wherein the scheduler comprises a controller with a constraint that limits a quantity of request-and-acknowledgement handshakes that can be supported by the controller, the quantity of request-and-acknowledgement handshakes that can be supported by the controller being less than a quantity of the multiple first entities.

Example 15: The apparatus of example 14, wherein:
the controller comprises a software-based controller that is single threaded; and
the quantity of request-and-acknowledgement handshakes that can be supported by the software-based controller is one.

Example 16: The apparatus of any one of examples 8 to 15, wherein the handler is further configured to:
receive, from the second entity, multiple secondary acknowledgement signals, at least two subsets of the multiple secondary acknowledgement signals asserted at the different time intervals, the multiple secondary acknowledgement signals respectively corresponding to the multiple first entities; and
transmitting, to the scheduler, a primary acknowledgement signal that is asserted based on all of the secondary acknowledgement signals being asserted.

Example 17: The apparatus of example 16, wherein the handler is further configured to:
receive, from the scheduler and prior to the reception of the multiple secondary acknowledgement signals, a primary request signal that is asserted; and
transmit, to the second entity and prior to the reception of the multiple secondary acknowledgement signals, multiple secondary request signals that are asserted, the multiple secondary request signals respectively corresponding to the multiple first entities.

Example 18: The apparatus of example 17, wherein the handler is further configured to:
receive, from the second entity, a secondary acknowledgement signal of the multiple secondary acknowledgement signals, the received secondary acknowledgement signal being asserted; and
de-assert, based on the received secondary acknowledgement signal being asserted, a secondary request signal of the multiple secondary request signals that corresponds to the received secondary acknowledgement signal.

Example 19: The apparatus of example 18, wherein the handler is further configured to:
receive, from the scheduler and after the transmission of the primary acknowledgement signal, the primary request signal that is de-asserted; and
reset, based on the primary request signal being de-asserted, a configuration of the handler to enable the multiple secondary request signals to be re-asserted based on a later assertion of the primary request signal.

Example 20: The apparatus of example 19, wherein the handler is further configured to refrain from reasserting the multiple secondary request signals prior to the reception of the primary request signal that is de-asserted.

What is claimed is:

1. A method performed by a handler, the method comprising:
executing a one-to-multiple request-and-acknowledgement handshake between a scheduler and a second entity, the scheduler associated with multiple first entities, the executing comprising:
performing a request-and-acknowledgement handshake with the scheduler;
performing multiple request-and-acknowledgement handshakes with the second entity, at least two subsets of the multiple request-and-acknowledgement handshakes completing at different time intervals, the multiple request-and-acknowledgement handshakes respectively associated with the multiple first entities; and
completing the request-and-acknowledgement handshake with the scheduler based on the completion of the multiple request-and-acknowledgement handshakes with the second entity.

2. The method of claim 1, wherein the execution of the one-to-multiple request-and-acknowledgement handshake enables data to be transferred between the second entity and the first entities.

3. The method of claim 1, wherein:
the performing of the multiple request-and-acknowledgement handshakes comprises receiving, from the second entity, multiple secondary acknowledgement signals, at least two subsets of the multiple secondary acknowledgement signals being asserted at the different time intervals, the multiple secondary acknowledgement signals respectively corresponding to the multiple first entities; and
the completing of the request-and-acknowledgement handshake with the scheduler comprises transmitting, to the scheduler, a primary acknowledgement signal that is asserted based on all of the multiple secondary acknowledgement signals being asserted.

4. The method of claim 3, wherein:
the performing of the request-and-acknowledgement handshake with the scheduler comprises, receiving, from the scheduler and prior to the receiving of the multiple secondary acknowledgement signals, a primary request signal that is asserted; and
the performing of the multiple request-and-acknowledgement handshakes comprises, transmitting, to the second entity and prior to the receiving of the multiple secondary acknowledgement signals, multiple secondary request signals that are asserted, the multiple secondary request signals respectively corresponding to the multiple first entities.

5. The method of claim 4, wherein the receiving of the multiple secondary acknowledgement signals comprises:
receiving, from the second entity, a secondary acknowledgement signal of the multiple secondary acknowledgement signals, the received secondary acknowledgement signal being asserted; and
de-asserting, based on the received secondary acknowledgement signal being asserted, a secondary request signal of the multiple secondary request signals that corresponds to the received secondary acknowledgement signal.

6. The method of claim 5, further comprising:
receiving, from the scheduler and after the transmitting of the primary acknowledgement signal, the primary request signal that is de-asserted; and
resetting, based on the primary request signal being de-asserted, a configuration of the handler to enable the multiple secondary request signals to be re-asserted based on a later assertion of the primary request signal.

7. The method of claim 6, further comprising:
prior to the receiving of the primary request signal that is de-asserted, refraining from reasserting the multiple secondary request signals.

8. An apparatus comprising:
a handler configured to:
be coupled between a scheduler and a second entity, the scheduler associated with multiple first entities;
perform a request-and-acknowledgement handshake with the scheduler;
perform multiple request-and-acknowledgement handshakes with the second entity, at least two subsets of the multiple request-and-acknowledgement handshakes completing at different time intervals, the multiple request-and-acknowledgement handshakes respectively associated with the multiple first entities; and
completing the request-and-acknowledgement handshake with the scheduler based on the completion of the multiple request-and-acknowledgement handshakes with the second entity.

9. The apparatus of claim 8, further comprising:
a system-on-chip comprising:
the handler;
the second entity; and
a subsystem comprising the scheduler and the multiple first entities.

10. The apparatus of claim 9, wherein the multiple first entities are associated with a same physical domain or a same power domain of the subsystem.

11. The apparatus of claim 9, wherein the second entity and the first entities are configured to communicate data based on the completion of the request-and-acknowledgement handshake between the scheduler and handler and based on the completion of the multiple request-and-acknowledgement handshakes between the second entity and the handler.

12. The apparatus of claim 11, wherein:
the second entity is configured to transmit the data to the first entities; or
the first entities are configured to transmit the data to the second entity.

13. The apparatus of claim 12, wherein:
the data comprises data associated with a built-in self-repair procedure;
the second entity and the first entities each comprise built-in self-repair controllers;
the first entities are coupled to memory components of the subsystem; and
the second entity is configured to transmit the data associated with the built-in self-repair procedure to the first entities.

14. The apparatus of claim 9, wherein the scheduler comprises a controller with a constraint that limits a quantity of parallel request-and-acknowledgement handshakes that can be performed in parallel, the quantity of request-and-acknowledgement handshakes that can be supported by the controller being less than a quantity of the multiple first entities.

15. The apparatus of claim 14, wherein:
the controller comprises a software-based controller that is single threaded; and
the quantity of request-and-acknowledgement handshakes that can be supported by the software-based controller is one.

16. The apparatus of claim 8, wherein the handler is further configured to:
receive, from the second entity, multiple secondary acknowledgement signals, at least two subsets of the multiple secondary acknowledgement signals asserted at the different time intervals, the multiple secondary acknowledgement signals respectively corresponding to the multiple first entities; and
transmitting, to the scheduler, a primary acknowledgement signal that is asserted based on all of the secondary acknowledgement signals being asserted.

17. The apparatus of claim 16, wherein the handler is further configured to:
receive, from the scheduler and prior to the reception of the multiple secondary acknowledgement signals, a primary request signal that is asserted; and
transmit, to the second entity and prior to the reception of the multiple secondary acknowledgement signals, multiple secondary request signals that are asserted, the multiple secondary request signals respectively corresponding to the multiple first entities.

18. The apparatus of claim 17, wherein the handler is further configured to:
receive, from the second entity, a secondary acknowledgement signal of the multiple secondary acknowledgement signals, the received secondary acknowledgement signal being asserted; and
de-assert, based on the received secondary acknowledgement signal being asserted, a secondary request signal of the multiple secondary request signals that corresponds to the received secondary acknowledgement signal.

19. The apparatus of claim 18, wherein the handler is further configured to:
receive, from the scheduler and after the transmission of the primary acknowledgement signal, the primary request signal that is de-asserted; and
reset, based on the primary request signal being de-asserted, a configuration of the handler to enable the multiple secondary request signals to be re-asserted based on a later assertion of the primary request signal.

20. The apparatus of claim 19, wherein the handler is further configured to refrain from reasserting the multiple secondary request signals prior to the reception of the primary request signal that is de-asserted.
